(19) United States
(12) Patent Application Publication
(10) Pub. No.: US 2023/0226494 A1
(43) Pub. Date: Jul. 20, 2023

(54) PROCESS AND APPARATUS FOR HIGH RECOVERY IN ELECTRODIALYSIS AND ELECTRODEIONIZATION SYSTEMS

(71) Applicant: IONIC SOLUTIONS LTD., Rancho Mirage, CA (US)

(72) Inventor: Azaroghly YAZDANBOD, Calgary (CA)

(21) Appl. No.: 18/097,787

(22) Filed: Jan. 17, 2023

Related U.S. Application Data
(60) Provisional application No. 63/300,193, filed on Jan. 17, 2022.

(51) Int. Cl. B01D 61/54; B01D 61/46; B01D 61/42; C02F 1/469

(52) U.S. Cl. CPC B01D 61/54; B01D 61/463; B01D 61/427; C02F 1/4693; C02F 1/4698; B01D 61/48

(57) ABSTRACT

Electrodeionization and electrodialysis systems which eliminate or substantially prevent the feed water from entering the concentrating compartments, for improving the recovery of product water as well as improving the current efficiency. Electro-osmotically generated flows of water entering from the diluting compartments of the stack constitutes the majority of concentrate feed, leading to the production of high purity, desalinated waters in the diluting compartments and highly concentrate solutions in the concentrate compartments.

### CROSS REFERENCES TO RELATED APPLICATION

The present application claims the benefit of U.S. Provisional Application No. 63/300,193 filed Jan. 17, 2022, the entire disclosure of which is hereby incorporated by reference.

### FIELD OF THE INVENTION

The present invention relates in general to the removal of ions from conductive electrolyte solutions such as seawater, brackish water, feed waters used for the production of ultra pure water, and ion-containing industrial solutions, and more particularly to electrodialysis and electrodeionization devices and methods for desalination, deionization, purification and/or decontamination of water and industrial solutions.

### BACKGROUND OF THE INVENTION

Devices employed for removing dissolved ions from electrolyte solutions using electric fields include electrodialysis and electrodeionization devices. Such devices can be used for desalination of saltwater, deionization of low conductivity waters and removal of ionic contaminants from solutions containing such ions. A typical electrodialysis/electrodeionization cell includes a series of diluted or “dilute” compartments alternating with concentrated or “concentrate” compartments formed within the device, by the action of a direct current electric field transversely passing through the membranes and the compartments formed between them. These multiple paired compartments are typically arranged into a configuration known in the art as a “stack”, made of alternating anion-selective and cation-selective membranes separated from one another by spacers positioned between adjacent membranes. Thus, “electrodialysis cells” and “electrodeionization cells” generally include the combination of a stack, a pair of electrodes each housed in an endplate, each on one side of the stack, a DC power supply, and input and output fluid flow channels/passages. The stacks start on each side with a so-called end spacer that helps isolate the solutions in the electrode compartments from the feed, the dilute, and the concentrate stream. The remainder of the stack is made up of pairs of ion-selective membranes (anion and cation), with regular spacers between the membranes, the final membrane bounded by a second end spacer.

In both electrodialysis and electrodeionization cells, the “input” electrolyte solution is typically directed through specific flow channels positioned in supporting endplates, which, in combination with flow passages in the ion-selective membranes and spacers, enable the independent flow of liquids in the concentrate and dilute compartments. These end plates also house the electrodes of the stack. Ions in the input solution are subjected to an electric field established through the stack by application of a DC electric potential difference between the electrodes. The passage of the DC current through the stack of alternating anion-selective and cation-selective membranes results in the formation of alternating dilute and concentrate compartments, with ions being depleted from the dilute compartments and accumulated in the adjacent concentrate compartments, as is well known in the art.

The flow or conduction of ions in electrodialysis and electrodeionization stacks is governed by Ohms law (I=V/R). The electric current (I) of ions is directly proportional to the potential difference (voltage, V) applied across the stack and is inversely proportional to the electric resistance (R). Since electrodeionization cells typically involve the production of sparingly conductive waters and solutions such as high purity or ultrapure waters, the electric resistivity and resistance of these solutions is so high that the required voltages to establish a reasonable current without incorporation of electroactive media (ion exchange resins) in the spacers, as a means of facilitating the flow of ions become quite excessive. Such electroactive media define low electrical resistance paths for ion flows. Therefore, in electrodeionization cells, specific spacers are typically incorporated in various forms between adjacent ion-selective membranes that in addition to other functions, house the conductive electroactive media needed to facilitate ion flow.

The use of electroactive media is not required in electrodialysis systems that treat higher conductivity waters such as brackish waters and produce potable water. For these systems the spacers are typically made up of a mesh made up of non-conductive materials such as plastics, which allow for flow of water between the membranes. These spacers also typically have gasketed edges and punched holes with specific gasketed edges for prevention of leaks to the outside of the stack and between the stack compartments that also allow the independent flow of feed water into and out of the diluting and the concentrating compartments respectively, as is well known by the practitioners of this technology. Other functions of spacers in both electrodialysis and electrodeionization systems include facilitation of the independent flow of the liquids in the dilute and concentrate compartments, structural support, creation of volume within each compartment, and maintenance of separation between adjacent anion-selective and cation-selective membranes.

Most common electrodialysis and electrodeionization devices use conventional metallic electrodes, in which charges (e.g., electrons) are transferred across the metal-liquid interface. This electron transfer causes oxidation or reduction reactions to occur, depending on electrode polarity. Since such “redox” reactions are governed by Faraday's law (i.e., the amount of chemical reaction caused by the flow of current is proportional to the amount of electric charge passed), they are often called Faradaic reactions. Metallic electrodes thus establish an electric field through a solution via Faradic/redox/electrode reactions with the solutions surrounding them. If the potential difference between each electrode and the solution adjacent to it is less than the minimum potential to allow electrode reaction (charge exchange between the metallic electrode and the ions in the solution adjacent to it) there will be no electric field between the electrodes and no electric current will pass through the liquid between the electrodes.

In some electrodialysis devices the electrodes used are of the capacitive type, capable of absorbing large amounts of ions and capacitively establishing an electric field without the occurrence of electrode reactions. U.S. Pat. No. 10,329,174 to Yazdanbod (also the present inventor), which is incorporated herein by reference in its entirety, specifically teaches the use of high electric capacitance electrodes such as electric double layer capacitors (EDLC's), discusses the behavior of high electric capacitance electrodes in confined containers, the use of high electric capacitance electrodes as means of capacitive generation of electric fields and ionic currents, and polarity reversals as a means of avoiding electrode reactions.

In electrodialysis and electrodeionization devices in addition to the movement of ions, some water movement also occurs from the dilute compartments to the concentrate compartments. This water movement mainly occurs by three processes: (1) movement of water molecules attached to individual ions as hydration water; (2) movement of water by osmosis, and (3) movement of water from within the pore structure of the ion-selective membranes by electro-osmosis. Here, for the case of soluble salts in water, osmosis is defined as the spontaneous movement of solvent molecules (water) through a semi-permeable membrane from a region of lower solute concentration (from the more dilute solution) into a region of higher solute concentration (the more concentrated solution). Electro-osmosis is defined as the induced movement of water molecules filling the pores of a fine-grained porous media (in the case of electrodialysis and electrodeionization stacks, ion exchange membranes) by passage of hydrated ions through the same pores under the influence of an electric field. In electrodialysis and electrodeionization equipment, all these water transfer processes occur simultaneously and to varying degrees, depending on the specifics of the ion-selective membranes, the ion content of the input or feed solution, the ion content of the output product, the ion content of the product water and the electric current passing through the stack. These finding mean that although the primary goal in using electrodialysis and electrodeionization devices is to move the dissolved ions from the dilute compartments to the concentrate compartments, typically some water transfer to the concentrate compartments also occurs, thus reducing the volume of the desired output product, i.e., purified liquid produced in the dilute compartments. This reduces the efficiency of such devices in producing more purified liquids, such as desalinated or deionized water.

Current efficiency in electrodialysis and electrodeionization systems is a measure of how effectively ions are transported across the ion-selective membranes for a given applied current. When a given current “I” in amperes passes between the electrodes and through a dilute compartment for a given time “t” in seconds, the current efficiency is defined as the ratio of I*t (the total charge transferred between the electrodes through the power supply) to the ionic charge transferred from the dilute volume to the concentrate volume. As an example, if a current of 1.0 amperes passes for period of 100 seconds between the electrodes (equivalent to 100 Coulombs of charge) of an electrodialysis cell, and if during the same period an equivalent of 80 Coulombs of charge (ions) is measured to have been transferred from a dilute compartment to the two adjacent concentrate compartments, then the current efficiency is 80%.

Most available literature regarding current efficiency typically identify several phenomena as the cause of low current efficiency in electrodialysis and electrodeionization processes. These discussions range from claims that current efficiency is a function of feed concentration, to viewing current efficiency as a phenomenon affected by deficient membrane ion selectivity, water transfer by ion hydration, shunt currents, and back diffusion of ions from the concentrate to the dilute compartments. However, in electrodeionization devices, because of rather high voltage gradients used for the production of high purity or ultrapure water, low current efficiency is believed to also be the result of water splitting. In these types of systems, splitting of water to its constituents of H⁺ and OH⁻ is believed to be occurring at contact points between cation exchange membranes and anion resin beads and between anion exchange membranes and cation exchange resins beads (Electromembrane Desalination Processes for Production of Low Conductivity Water by Andrej Grabowski, 2010, pages 138 to 141). Current efficiency is calculated based on measurement of the salt concentration changes in the product water stream between the input and output steams and the measurement of electric current passing between the electrodes. Then, charge transfer between the dilute and concentrated compartments is calculated based on the equivalent charge of the ions moved, with due attention to the volume of the flow. By monitoring the electric current moving through the power supply, current efficiency is calculated based on the amount of charge moved out of the dilute compartments (or moved into the concentrate compartments) as compared to the charge moved through the power supply. This means that if the feed flow rates are measured and established at the input lines, as is the norm, and then as the process proceeds some water is transferred from the diluting compartments to the concentrate compartments, the flow rate of the dilute output would be less. Further, as the flow rate of the concentrate output increases due to the entry of water from the dilute compartments into the concentrate compartments, the concentrate output flow will not concentrate to the expected concentration. Furthermore, the recovery defined as the percent ratio of product to total input flows would be less than expected. In practice, this forces the operators to increase the input flow rate and also increase the current passing through the system by increasing the voltage, which results in higher energy consumption per volume of product water produced.

U.S. Pat. No. 9,586,841 to Yazdanbod (also the present inventor), which is incorporated herein by reference in its entirety and herein referred to as “the '841 patent”, identifies osmotic and electro-osmotic water transfer as a major cause of decreased current efficiency, and describes process and equipment for osmotic and electro-osmotic flow control in electrodialysis desalination equipment. The '841 patent teaches that in order to have a more realistic assessment of system current efficiency, salinity measurements should not only consider the flow into each compartment, but also the flow coming out of them. In other words, the '841 patent teaches that although ions move across the membranes rather effectively, replacement of the lost contents of the dilute compartments by additional feed and replacement of the contents of the concentrate compartments by water moving into them from the dilute compartments effect the calculated value of current efficiency. This patent also shows that imposition of higher pressures in the concentrate compartments can reduce, and in ideal conditions can eliminate osmotic and electro-osmotic water transfer from dilute compartments to the concentrate compartments. It also shows that by creating constant volume dilute compartments, which result in constant volume concentrate compartments along with closure of valves on input and output lines to the concentrate compartments, the needed pressures in the concentrate compartments to control the osmotic and the electro-osmotic flow of water from dilute compartments to concentrate compartments can be automatically created without the need for pumps. The '841 patent thus illustrates that once the volume of the concentrate compartments is held constant, then the tendency of water to move by osmosis and/or electroosmosis from the dilute compartments into the concentrate compartments leads to an automatic pressure buildup in the concentrate compartment. The '841 patent also teaches that buildup of pressure in the concentrate compartments reduces, and in optimum conditions eliminates, osmotic and electro-osmotic water flow from the dilute to the concentrate compartments, therefore improving the current efficiency of the system.

The '841 patent also teaches that rather than waiting for the automatic and gradual buildup of hydrostatic pressure in the concentrate compartments to reduce electro-osmotic and osmotic flow from the dilute into the concentrate compartment, there are cases wherein the simple application of pressure to the concentrate compartments along with closure of the input and the output valves can be more effective in improving the current efficiency. This means that in many cases external pumps can provide a faster increase in pressure in the concentrate compartments, which can result in higher production of dilute output product.

In any case, when pressures (automatically developed or applied) are used in electrodialysis equipment, attention should also be paid to potential damage to the ion-selective membranes by tensile failure or bursting, and potential blockage of dilute compartments by rapidly expanding pressurized concentrate compartments. Further, as with current spacers the seals between the concentrating and the diluting compartments are not perfect, pressurizing the concentrate compartments results in leakage of the flow from the concentrate compartments into the diluting compartments and increasing its salinity, reducing the effectiveness of the system. Therefore, while electrodialysis devices and methods are known for improving the current efficiency for electrodialysis processes (e.g., the '841 patent), there currently is no device or method for improving the current efficiency of electrodialysis systems that operate in a continuous flow mode for the concentrate and without the need to pressurize the concentrate.

Electrodeionization devices differ from electrodialysis devices in that they are typically used for the production of higher purity products such as ultrapure water, and can include voluminous spacers (spacers that have enough volume), typically filled with electroactive media such as ion exchange resins, placed between the ion-selective membranes to facilitate the conduction of ions in the low conductivity feed and sparingly conductive product waters in such devices. In comparison, electrodialysis devices use spacers that are made up of plastics and include a central portion and a sealing gasket that are non-conductive and are mainly used to facilitate the flow of water between adjacent membranes while keeping them apart. Further, current electrodeionization devices and their related control systems have no mechanism to reduce or eliminate osmotic and electro-osmotic flow of water from dilute compartments to the concentrate compartments. This means that simple application of differential pressure between the concentrate and the dilute compartments of current electrodeionization devices would lead to volume changes in these compartments leading to compaction and volume reduction of the resin beads used within the spacers in both sets of dilute and/or concentrate compartments. This could then lead to separation or reduced contact between the resin beads themselves and between the resin beads and major sections of the ion exchange membranes. These separations then lead to an increase in the total resistivity of the device and hinder its proper performance. This is why the majority of operational manuals for the existing electrodeionization devices prohibit or advise against development of differential pressures between the concentrate and the dilute compartments.

In light of the above, it is apparent that it would be beneficial to provide electrodialysis and electrodeionization devices and processes that can improve current efficiency and recovery of such systems without the need to pressurize the concentrate.

### SUMMARY OF THE INVENTION

Accordingly, a first aspect of the invention provides a method for improving the current efficiency and recovery of an electrodialysis system having a plurality of ion exchange membranes placed adjacent to one another and a plurality of spacers compressed between each of the plurality of ion exchange membranes, each of the plurality of ion exchange membranes creating a concentrate compartment on one side and a dilute compartment on the other side when the system is filled with a feed solution and acted upon by a direct current passing through the stack, the method comprising operating the electrodialysis system without providing feed solution to the concentrate compartments.

A second aspect of the invention provides a method for improving current efficiency and recovery of an electrodialysis system, wherein the electrodialysis system comprises: a first electrode compartment housing a first electrode; a second electrode compartment housing a second electrode; a plurality of ion exchange membranes placed between the first and second electrode and adjacent to one another, each of the plurality of ion exchange membranes creating a concentrate compartment on one side and a dilute compartment on the other side when the electrodialysis system is filled with a feed solution and acted upon by a direct current passing therethrough; a plurality of spacers, each of the plurality of spacers being placed between opposing ion exchange membranes; a support structure for compressing and holding the electrode compartments, the spacers, and the ion exchange membranes together; a plurality of input lines for supplying feed solution to the dilute compartments, the concentrate compartments, and the electrode compartments; and a plurality of output lines for removing product solution from the dilute compartments, the concentrate compartments, and the electrode compartments, wherein each of the plurality of input lines and each of the plurality of output lines includes a valve for controlling the flow into and out of the compartments, wherein the method comprises the steps of: (1) delivering feed solution to the concentrate compartments and the dilute compartments via the input lines; (2) thereafter restricting the flow in the input line of the concentrate compartments to prevent further delivery of the feed solution to the concentrate compartments while continuing to deliver the feed solution to the diluting compartments; (3) passing the direct current through the electrodialysis system, wherein a concentrated solution is formed in the concentrating compartments and a dilute solution is formed in the dilute compartments; and (4) thereafter removing concentrated product solution from the concentrate compartments and dilute product solution from the dilute compartments, wherein the diluted stream recovery is equal to or greater than 80%. In some cases the diluted stream recovery can be higher than 90%, and in many cases higher than 95% depending of the electroosmotic flow potential of the membranes and the current imposed.

The nature and advantages of the present invention will be more fully appreciated from the following drawings, detailed description, and claims.

### BRIEF DESCRIPTION OF THE DRAWINGS

The accompanying drawing illustrates a preferred embodiment of the invention and, together with a general description of the invention given above, and the detailed description given below, serves to explain the principles of the invention.

FIG. 1 is a schematic presentation of an electrodialysis stack according to the present invention, showing the pattern of ion and electro-osmotically generated water flows.

### DETAILED DESCRIPTION OF THE INVENTION

Definitions—As defined herein, the terms “ion” or “ions” refer to atoms or molecules with a net electric charge due to the loss or gain of one or more electrons. In electrolytes, ions are hydrated ions which means that they are covered by a shell of water molecules. The amount of charge of an ion depends on the number of electrons lost or gained. For any ion missing or gaining one electron, the net charge is equal to that of an electron, which is equal to 1.60217662×10⁻¹⁹ Coulombs. This results in the fact that one mole of electrons is equivalent to Avogadro's number (6.02214×10²³) of electrons or 96,485.3 Coulombs.

As used herein, the terms “electrolyte” and “electrolyte solution” are interchangeable when used in this document and are therefore applicable to any solute or chemically defined salt dissolved in any polar liquid, wherein the result is the formation of an electrolyte solution. Therefore, when referring to “ion-containing” or “salty” waters, irrespective of the number of salts present in unit volume of the liquid, it is to be interpreted as to mean and include an electrolyte solution. As such, the term “water” can mean any polar solvent and the term “salt” can mean any solute that together with a polar solvent forms an electrolyte solution.

As used herein the terms “ion exchange membranes” and “ion selective membranes” are interchangeable, and include cation exchange membranes, anion exchange membranes, cation selective membranes, and anion selective membranes.

As used herein the terms “electroactive media” and “ion exchange resin beads” are interchangeable and can include any shape or form which can perform the intended function of conducting ions in a sparingly conductive solution under the influence of an electric field, while maintaining sufficient mechanical integrity. Many types of electroactive media can be used to define a lower resistance path for ion flow. The most common type is in the form of ion exchange resin beads, but electroactive media can also be in the form of beads bonded to one another by a bonding agent, or in the form of fabrics, and depending on the specifics of a design could be mixed anion and cation exchange beads or singular polarity bead layers filling one compartment or distinct sections of both types of resin beads in a single compartment.

The terms “electrodeionization” and “electrodialysis” as used in this document are technically different. As noted earlier, electrodeionization devices are typically used for production of higher purity products from higher purity feeds while electrodialysis systems are used to produce water for such uses as human consumption from brackish waters and seawater. Further, electrodeionization systems may be distinguished from electrodialysis systems by incorporation of specific voluminous spacers (or separators) placed between the ion-selective membranes while electrodialysis devices typically use rather thin spacers made of a plastic mesh. Such spacers, as they apply to the present invention and electrodeionization devices, are typically filled with electroactive media such as ion exchange resin beads, which facilitate ion flow in the low conductivity input and sparingly conductive high purity output product which is generated in the dilute compartments. Further, while electrodialysis systems are typically used for input solutions having 1000 mg/liter and higher salt content, such as brackish water and seawater, electrodeionization systems typically are used for input solutions already having a low salt content, such as aqueous salt solutions that are the product of passing through one or more reverse osmosis systems. Typically, these feeds have conductivities of less than 50 μS/cm corresponding to about 18 to 20 ppm equivalent NaCl.

The present invention provides a method for improving the current efficiency and recovery of an electrodialysis cell or system by operating the system without any concentrate feed. Specifically, if feed flow is only provided to the dilute feed and a DC current is imposed on the system, concentrate flow can be generated by the electro-osmotic flow of water into the concentrating compartments from the dilute compartments. As a result, electro-osmosis generates the concentrate flow, which can also be regulated with the external imposition of back pressure. The rate of concentrate flow can then be a function of the electric current imposed and would be lower than any electrodialysis or electrodeionization that allow the supply of some feed flow to the concentrate compartments. The degree of concentration is also naturally governed by the current imposed that also determines the degree of desalination of the dilute compartments.

With the technique described herein, the feed to the concentrate compartments is cut off, and it has been observed that if, for example, the total feed into the dilute compartments is 100 liters per hour, there is still a significant concentrate flow of about 10 litres per hour without any back pressure, which could be reduced even further by imposition of some back pressure. The recovery could then be higher (e.g. about 95% and more). Further as the water flow into the concentrate compartments will also carry the ion flows the current efficiency would now be close to 100%. Thus, it is proposed herein that current efficiency of electrodeionization and electrodialysis systems can be improved through complete or partial cut-off of the concentrate feed.

Removal or major reduction of the concentrate feed can allow the output flow from the concentrate compartments to be principally generated from electro-osmotic flow into the concentrate compartments from the diluting compartments. To operate under the provisions of this invention, the two sets of compartments of any electrodialysis or electrodeionization cell is first filled with the feed flow. Then, while continuously flowing the feed in the dilute compartments, the input flow to the concentrating compartments is stopped or severely restricted, by such means as fully or partially closing the feed line by a valve, or by shutting down or slowing down the related concentrate flow pump, combined with the application of the DC current across the stack while leaving the concentrate output line open. As the cell is charged and as ions begin to move from diluting compartments into the concentrating compartments through the stack membranes by the application of the electric field generated by the potential difference applied between the electrodes, electro-osmotically generated water flow also occurs, feeding water into the concentrate compartments from the dilute compartments. The combination of the ionic and water flows constitutes the concentrate flow entering the concentrate compartments. The high recoveries achievable also leads to very high concentration of the concentrate solution generated that in addition to saving valuable water resources could be used in many industrial processes to concentrate the ion containing solutions such as for concentration of lithium eluates.

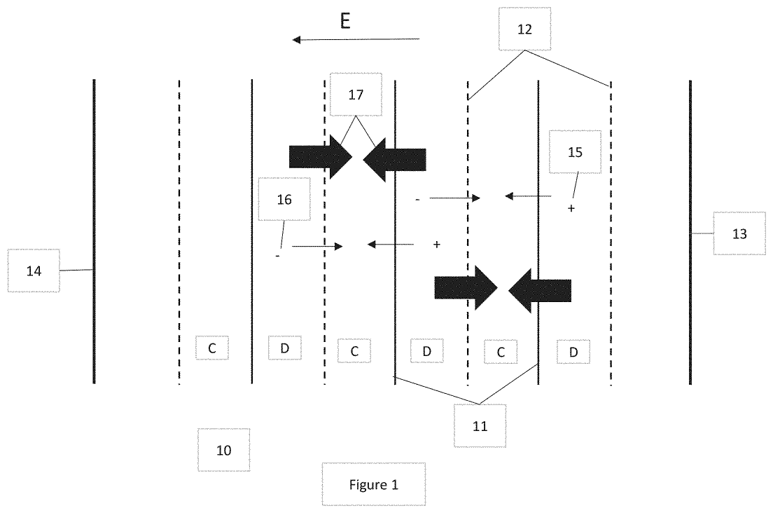

FIG. 1 is a schematic representation of an electrodeionization and/or an electrodialysis stack 10 which includes the combination of cation exchange membranes 11 alternately placed between anion exchange membranes 12 (dotted lines), a positively charged electrode 13, and a negatively charged electrode 14, as is well known in the art. Spacers, which are typically present between adjacent ion exchange membranes 11, 12, are not shown. As illustrated, the direction of the electric field “E” is from the positive electrode 13 towards the negative electrode 14. Once the electric field “E” is established through the saline solution filled stack, positively charged ions 15 are caused to flow or otherwise move in the same direction as the electric field “E” as shown, passing through the cation exchange membranes 11 and entering the concentrating compartments “C”. The positive ions 15 enter and accumulate in the concentrate compartments “C”, and are prevented from further movement out of these compartments by the anion exchange membranes 12 located downstream of their direction of flow. Correspondingly, negatively charged ions 16 move in the opposite direction of the electric field “E” as shown and pass through the anion exchange membranes 12, also entering and accumulating in the concentrating compartments “C”. Similarly, further movement of the negative ions 16 out of these compartments is prevented by the cation exchange membranes 11 located downstream of the direction of movement of the negative ions 16. Based on the principal of electroneutrality, the oppositely charged ions 15, 16 accumulate and balance one another out.

As illustrated in FIG. 1, as the positive and negative ions 15, 16 move (small arrows) through the ion exchange membranes 11, 12 they induce electro-osmotic water flows 17 (large arrows). The direction of electro-osmotic flow is from the diluting compartments “D” to the concentrating compartments “C”. The present invention posits delivering the feed saline solution into the diluting compartments “D” while preventing feed solution from entering the concentrating compartments “C”. In this manner, a concentrated solution is formed in the concentrating compartments “C” by the combined flow of electro-osmotic water flow 17 and ion flows 15, 16. This concentrated solution gradually fills the concentrating compartments “C”, replacing the feed solution already in them, and begins to flow out of the stack. Specifically, the fluid which enters the concentrating compartments “C”, referred to herein as the “concentrate output”, will leave the stack 10 through outlet passages present in the membranes 11, 12, the spacers (not shown), and through passages in the end plates, as is known in the art.

Based on the above it can be postulated that, as the concentrate flow is generated by electroosmotic flow, which also contains all of the ion flows from the diluting compartments to the concentrating compartments, the current efficiency of an electrodialysis system using the process described herein can result in current efficiencies approaching 100%. Further, since the electroosmotic flow normally constitutes a very small fraction of the feed flow, product (diluted) stream recovery (defined as the ratio of the product flow to total feed flow) can exceed 95%, and may reach greater than 99%, depending on the salinity of the feed, the degree of desalination effected, and the current density used.

In certain embodiments of this invention, and based on such considerations as prevention of precipitation, an appropriate volume of feed can be initially directed into the concentrate compartments, for example, to fill and de-air the system. The high recoveries possible under this invention results in rather very small concentrate flows. This means that initially, as a given cell is put into operation, the concentrate flow generated will gradually achieve its highest concentration. In other embodiments, the additional feed input to the concentrate compartments can include such solutions as acidified or anti-scalant containing solutions, to prevent precipitation of the concentrate solutions generated within the concentrate compartments.

### Test Equipment and Methods

The electrodialysis cells/systems which were used in the tests reported herein were equipped with 15 pairs of anion exchange and cation exchange membranes, each with a net ion flow area of 9.5 cm width and 9.0 cm length. In one set of tests, the cell used was constructed using Type 10 Fujifilm membranes and with 3 equal hydraulic stages of 5 sets of membranes each. In a second set of tests, the membranes used were acquired from Membranes International Inc. These second set of anion exchange membranes and the cation exchange membranes were type Ami-7001 and Cmi-7000 respectively. The electrodialysis cell in the second set of tests was constructed with 15 pairs of membranes, but in a single hydraulic stage. The test cells were operated in electrodialysis reversal mode (EDR) with polarity reversal timing of 30 to 60 minutes. Plastic mesh spacers with silicon rubber gasketed edges were used. The cells were proven to be perfectly sealed at dilute feed pressures which were typically less than 0. Bars.

The electric field in the cells used were generated by capacitive electrodes similar to the ones described in U.S. Pat. No. 10,329,174 to Yazdanbod (also the present inventor). The power supply used was a timer-controlled polarity reversal DC current control system manufactured in house and its calibration was verified using a Keysight U3606B Multimeter/DC Power. The flow reversal was affected with two Tsai Fan three-way motorized valves (model no: TF8-BH3-B) on feed lines and the same on the output lines. The valves switched the dilute and the concentrate feed lines from one set of cell compartments to the other set as polarity of the DC power supply reversed. The pumps used were UXCELL DC 12 V, 300 mA, 1300 ml Micro Water Pumps. One pump was connected to the dilute feed system that switched between the two sets of the cell compartments using the three-way vales, and another pump was similarly connected to the concentrate feed system. This pump was turned off and was isolated with a manual valve after establishing the initial flow in the cell, thus cutting off the feed to the concentrate compartments. The TDS (Total dissolved Salts) values for feed, dilute, and concentrate streams were measured using a REED SD-4307 Electrical Conductivity Meter, which was routinely calibrated.

### Test Results

Although a large number of tests have been carried out, 4 test results viewed as more representative are presented here. In all these tests the feed water was initially directed to both the diluting and the concentrating compartments to fill and de-air the cell. Then the concentrate feed pump was turned off and its feed line was closed using a valve which was also placed on this line. The cell was then powered up.

TABLE 1
Test results

| | | | | Feed | | Dilute | Cell | Current | Current | Electroosmotic |
|---|---|---|---|---|---|---|---|---|---|---|
| | | Hydraulic | membrane | Flow | Feed TDS | Recovery | Current | Density | Efficiency | Flow |
| Test # | Membranes | Stages | Pairs | mL/min | ppm | % | Amps | Amps/m2 | % | ml/m2/Hour |
| 1 | Fuji Type 10 | 3 | 15 | 214 | 3040 | 99.3 | 0.25 | 29.2 | 100.0 | 351.0 |
| 2 | Fuji Type 10 | 3 | 15 | 220 | 2950 | 99.1 | 0.40 | 46.8 | 100.0 | 456.0 |
| 3 | Fuji Type 10 | 3 | 15 | 208 | 2965 | 98.9 | 0.50 | 58.5 | 100.0 | 538.0 |
| 4 | Membranes | 1 | 15 | 403 | 1305 | 98.0 | 0.35 | 40.9 | 100.0 | 1871.0 |
| | International | | | | | | | | | |

These tests were carried out using the setup described in relation to FIG. 1. In most these tests and within a period of 45 minutes from the start of power application the concentration of the concentrate stream surpassed 20 to 25 times the feed salinity. This means that for input feed TDS (Total Dissolved Salts) values of about 3000 ppm, the concentrate stream generated achieved TDS between 60,000 to 75,000 ppm. These tests show that by restricting the concentrate flow to electroosmotic flow, very high recoveries, high current efficiencies, and high concentrate concentrations can be achieved. Therefore, this process can be effective in producing high quality dilute solutions and high concentration output solutions. Such high-quality solutions can have many uses in industrial processes, such as in the production and extraction of lithium compounds. Further, this process can be effective in increasing the product desalinated water recovery in electrodialysis systems to much higher than 95%.

When dealing with hard waters that have high precipitation potential due to the presence of such ions as calcium and magnesium carbonates and sulfates, such highly concentrated solutions generated by the use of this process can lead to appreciable precipitation of such chemicals in the concentrating compartments. The most common means for reduction of the precipitating potential in electrodialysis systems are the lowering of the concentrate pH by acid addition or addition of anti-scalants to the concentrate feed. The same approach can be used when using the subject process disclosed herein. This means that small dosing pumps can be used to input an acid solution or solutions rich in anti-scalants into the concentrate compartments as a means of preventing the precipitates from forming in the concentrate compartments.

One major advantage of the use of this high recovery method for electrodeionization systems and for the desalination of brackish waters, is that not only would the product water recovery be higher, but that the current efficiency would approach 100 percent, which reduces the energy consumption. Another advantage is that because the conductivity of the solutions in the concentrate compartments is much higher than comparable lower recovery systems, the required potential difference for generation of a given current through the cell would be lower, which in turn leads to lower energy consumption.

In the case of desalination of low salinity waters and deionization of water for the production of ultrapure water, higher electro-osmotic flow rates can also be regulated and reduced by the employment of a pressure regulating valve on the concentrate output line. The utilization of the process of this invention, combined with restriction of the electro-osmotically generated concentrate flow, can lead to some pressure buildup in the concentrate compartments, which can further reduce the concentrate output flow rate.

While the present invention has been illustrated by the description of embodiments and examples thereof, it is not intended to restrict or in any way limit the scope of the accompanying claims to such detail. Additional advantages and modifications will be readily apparent to those skilled in the art. Accordingly, departures may be made from such details without departing from the scope of the invention.

What is claimed is:

1. A method for improving the current efficiency and recovery of an electrodialysis system, the electrodialysis system comprising a plurality of ion exchange membranes placed adjacent to one another and a plurality of spacers compressed between each of the plurality of ion exchange membranes, each of the plurality of ion exchange membranes creating a concentrate compartment on one side and a dilute compartment on the other side when the system is filled with a feed solution and acted upon by a direct current passing therethrough, wherein the method comprises operating the electrodialysis system without providing feed solution to the concentrate compartments.

2. The method of claim 1, the electrodialysis system further comprising a first electrode compartment housing a first electrode, a second electrode compartment housing a second electrode, a support structure for compressing and holding the electrode compartments, the spacers and the ion exchange membranes together, a plurality of input lines for supplying feed solution to the dilute compartments, the concentrate compartments, and the electrode compartments, and a plurality of output lines for removing product solution from the dilute compartments, the concentrate compartments, and the electrode compartments, wherein each of the plurality of input lines and each of the plurality of output lines includes a valve for controlling the flow into and out of the electrodialysis system.

3. A method for improving current efficiency and recovery of an electrodialysis system, wherein the electrodialysis system comprises:
(a) a first electrode compartment housing a first electrode;
(b) a second electrode compartment housing a second electrode;
(c) a plurality of ion exchange membranes placed between the first and second electrode and adjacent to one another, each of the plurality of ion exchange membranes creating a concentrate compartment on one side and a dilute compartment on the other side when the electrodialysis system is filled with a feed solution and acted upon by a direct current passing therethrough;
(d) a plurality of spacers, each of the plurality of spacers being placed between opposing ion exchange membranes;
(e) a support structure for compressing and holding the electrode compartments, the spacers, and the ion exchange membranes together;
(f) a plurality of input lines for supplying feed solution to the dilute compartments, the concentrate compartments, and the electrode compartments; and
(g) a plurality of output lines for removing product solution from the dilute compartments, the concentrate compartments, and the electrode compartments, wherein each of the plurality of input lines and each of the plurality of output lines includes a valve for controlling the flow into and out of the compartments,
wherein the method comprises the steps of:
i) delivering feed solution to the concentrate compartments and the dilute compartments via the input lines;
ii) thereafter restricting the flow in the input line of the concentrate compartments to prevent further delivery of the feed solution to the concentrate compartments while continuing to deliver the feed solution to the diluting compartments;
iii) passing the direct current through the electrodialysis system, wherein a concentrated solution is formed in the concentrating compartments and a dilute solution is formed in the dilute compartments; and
iv) thereafter removing concentrated product solution from the concentrate compartments and dilute product solution from the dilute compartments, wherein the diluted stream recovery is equal to or greater than 80%.

4. The method of claim 3, wherein over time substantially all of the flow through the output lines of the concentrate compartments is generated from electro-osmotic flow into the concentrate compartments from the diluting compartments.

5. The method of claim 4, wherein precipitation preventing solutions are later added to the concentrate compartments via the input lines of the concentrate compartments for preventing precipitation of solids within the concentrate compartments.

6. The method of claim 3, further comprising the step of pressurizing the concentrate compartments to reduce electro-osmotic flow between the dilute compartments into the concentrate compartments to further improve current efficiency.

7. The method of claim 3, wherein the diluted stream recovery is equal to or greater than 95%.

8. The method of claim 3, wherein the diluted stream recovery is greater than 99%.
